(19) United States
(12) Patent Application Publication
(10) Pub. No.: US 2015/0029624 A1
(43) Pub. Date: Jan. 29, 2015

(54) PROTECTION CIRCUIT AND PROTECTION APPARATUS INCLUDING THE SAME

(71) Applicant: SK hynix Inc., Icheon-si Gyeonggi-do (KR)

(72) Inventors: Yun Seok HONG, Icheon-si Gyeonggi-do (KR); Myung Hwan LEE, Cheonan-si Chungcheongnam-do (KR)

(73) Assignee: SK hynix Inc., Icheon-si Gyeonggi-do (KR)

(21) Appl. No.: 14/156,610

(22) Filed: Jan. 16, 2014

(30) Foreign Application Priority Data
Jul. 26, 2013 (KR) 10-2013-0088757

(51) Int. Cl. H02H 9/04

(52) U.S. Cl. CPC H02H 9/041
USPC 361/56

(57) ABSTRACT

A protection circuit includes a high voltage detection unit configured to activate a high voltage detection signal where a first voltage exceeds a predetermined voltage; and a discharge unit coupled with the first voltage in response to the high voltage detection signal, and configured to discharge the first voltage to a ground voltage in response to a voltage level acquired by dropping the first voltage.

### CROSS-REFERENCES TO RELATED APPLICATION

The present application claims priority under 35 U.S.C. §119(a) to Korean application number 10-2013-0088757, filed on Jul. 26, 2013, in the Korean Intellectual Property Office, which is incorporated herein by reference in its entirety.

### BACKGROUND

1. Technical Field

Various embodiments relate to a protection circuit and a protection apparatus including the same, and more particularly, to a protection circuit which includes a unit for blocking noise generated upon detection of a high voltage, and a protection apparatus including the same.

2. Related Art

An integrated circuit (IC) operates using voltages with various levels. In the case where abnormal noise is generated in an integrated circuit or an abnormal high voltage is applied from an outside, circuits inside the integrated circuit may break due to the influence of a high voltage. Thus, a protection circuit for detecting and discharging a high voltage is demanded.

### SUMMARY

A protection circuit and a protection apparatus which operate to detect a high voltage once more even when a high voltage detection circuit has detected a high voltage through a misoperation, thereby capable of blocking noise generated due to misoperation, are described herein.

Also, a protection circuit and a protection apparatus which can minimize power consumption in a normal operating situation are described herein.

Further, a protection circuit and a protection apparatus which quickly respond to a high voltage and perform a discharging operation are described herein.

In an embodiment of the present disclosure, a protection circuit includes: a high voltage detection unit configured to activate a high voltage detection signal where a first voltage exceeds a predetermined voltage; and a discharge unit coupled with the first voltage in response to the high voltage detection signal, and configured to discharge the first voltage to a ground voltage in response to a voltage level acquired by dropping the first voltage.

In an embodiment of the present disclosure, a protection apparatus includes: a protection circuit configured to activate a high voltage detection signal where a first voltage exceeds a predetermined voltage, and perform a discharging operation in response to the activated high voltage detection signal; and an internal circuit provided with the first voltage through the protection circuit.

In an embodiment of the present disclosure, a system comprises: a processor configured to interpret a command input from an external apparatus and control an operation according to an interpretation result of the command; an auxiliary storage device configured to store a program for interpretation of the command, and the information; a main storage device configured to transfer the program and information from the auxiliary storage device and store the program and the information so that the processor performs the operation using the program and information when the program is executed; and an interface device configured to perform communication between the external apparatus and one or more among the processor, the auxiliary storage device, and the main storage device, wherein at least one of the auxiliary storage device and the main storage device includes: a high voltage detection unit configured to activate a high voltage detection signal where a first voltage exceeds a predetermined voltage; and a discharge unit coupled with the first voltage in response to the high voltage detection signal, and configured to discharge the first voltage to a ground voltage in response to a voltage level acquired by dropping the first voltage.

Thanks to the above embodiments, a protection circuit may detect a high voltage while minimizing power consumption.

The protection circuit according to the embodiments of the present disclosure may stably perform a discharging operation despite high voltage detection noise generated due to the misoperation or reaction delay of a high voltage detection circuit.

### BRIEF DESCRIPTION OF THE DRAWINGS

Features, aspects, and embodiments are described in conjunction with the attached drawings, in which:

FIG. 1 is a block diagram showing an apparatus including a protection circuit in accordance with an embodiment of the present disclosure;

FIG. 2 is a block diagram showing the protection circuit in accordance with an embodiment of the present disclosure;

FIG. 3 is a circuit diagram showing an embodiment of the high voltage detection unit of FIG. 2; and

FIGS. 4 and 5 are circuit diagrams showing embodiments of the discharge unit of FIG. 2.

FIG. 6 is a block diagram illustrating a system according to an embodiment of the invention.

### DETAILED DESCRIPTION

Hereinafter, a protection circuit and a protection apparatus including the same according to the present disclosure will be described below with reference to the accompanying drawings through embodiments.

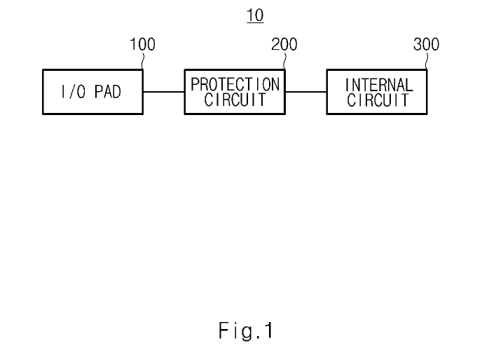

FIG. 1 is a block diagram showing an apparatus including a protection circuit in accordance with an embodiment of the present disclosure.

An apparatus 10 includes an input/output pad 100, a protection circuit 200, and an internal circuit 300.

The signal received through the input/output pad 100 is provided to the internal circuit 300 through the protection circuit 200. The protection circuit 200 is configured to detect a high voltage from the input/output pad 100 and substantially prevent the internal circuit 300 from being damaged.

For instance, the voltage received from the input/output pad 100 may instantaneously rise. Also, a high voltage may be generated due to mixing of noise from the input/output pad 100 upon power-on or bouncing of a voltage. The protection circuit 200 discharges an instantaneously increased voltage to a ground voltage and thereby protects the internal circuit 300.

In particular, in the case of a small-sized electronic appliance, it becomes the norm that it operates at a low voltage level to reduce power consumption. Accordingly, the internal circuit 300 itself may be likely to be damaged if an operating voltage rises even slightly, and thus, it is important to detect a fine voltage rise and perform a discharging operation.

Further, if a power supply voltage (VDD) is discharged to a ground voltage (VSS) even though it is not necessary to perform a discharging operation when instantaneous noise is generated, unnecessary power consumption may occur. Therefore, a discharging operation should be accurately initiated by precisely detect the fine voltage rise.

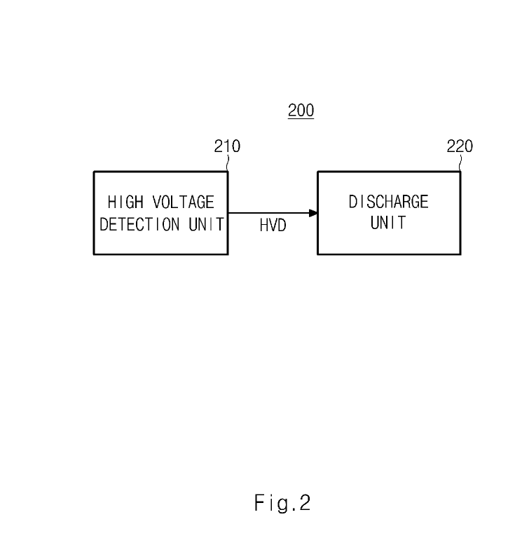

FIG. 2 is a block diagram showing the protection circuit 200 in accordance with an embodiment of the present disclosure.

Referring to FIG. 2, the protection circuit 200 includes a high voltage detection unit 210 and a discharge unit 220.

The high voltage detection unit 210 is configured to detect a first voltage higher than a predetermined voltage, generate a high voltage detection signal HVD, and provide the high voltage detection signal HVD to the discharge unit 220. The high voltage detection unit 210 may be configured to activate the high voltage detection signal HVD in the case where the first voltage exceeds the predetermined voltage. An internal circuit may be provided with the first voltage through the protection circuit 200.

The discharge unit 220 is configured to discharge the generated high voltage to a ground voltage VSS in response to the high voltage detection signal HVD.

When detecting a voltage higher than the predetermined voltage, the high voltage detection unit 210 is likely to respond to an instantaneous high voltage. In the case where an instantaneous high voltage is generated, since a normal voltage level may be immediately recovered, a separate discharging operation may not be necessary. If the discharging operation is performed in response to the instantaneous high voltage, unnecessary power consumption may occur. Furthermore, if the unnecessary discharging operation is continuously performed, a disadvantage may be caused in the case of a mobile appliance with limited power.

Therefore, the discharge unit 220 in accordance with an embodiment of the present disclosure does not perform a discharging operation in direct response to the high voltage detection signal HVD, and has a high voltage responding section which responds to the high voltage detection signal HVD. Also, the discharge unit 220 is configured to be capable of internally detecting a raised level of the power supply voltage (VDD) and not perform a discharging operation when instantaneous noise of the high voltage detection signal HVD is generated.

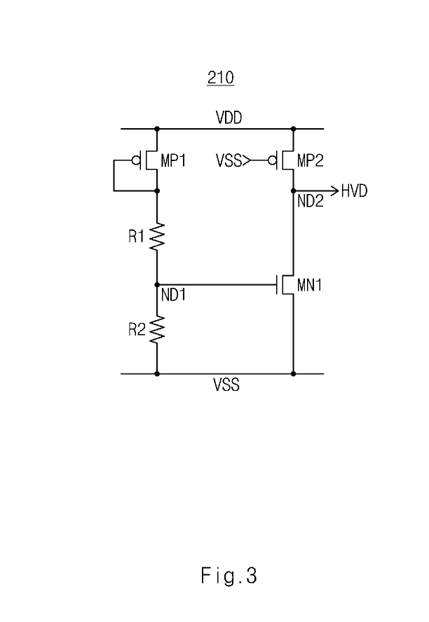

FIG. 3 is a circuit diagram showing an embodiment of the high voltage detection unit of FIG. 2.

Referring to FIG. 3, the high voltage detection unit 210 includes first and second PMOS transistors MP1 and MP2, first NMOS transistor MN1, and first and second resistors R1 and R2.

In detail, the first PMOS transistor MP1 has a first terminal which is coupled with a power supply voltage VDD and a second terminal which is coupled with the gate terminal. The gate terminal and the second terminal of the first PMOS transistor MP1 are coupled with one end of the first resistor R1. The first PMOS transistor MP1 may operate like a diode. The first PMOS transistor MP1 is designed such that the first NMOS transistor MN1 is not turned on when the power supply voltage VDD is within a normal range.

The first PMOS transistor MP1 (a voltage dropping element) is coupled in series with the first resistor R1 and the second resistor R2, (wherein the first resistor R1 forms a voltage divider with the second resistor R2), between the voltage of the first node ND1 and the ground voltage VSS. The high voltage detection unit 210 may further comprise at least one voltage dropping element and a voltage divider coupled in series between the voltage of the first node ND1 and the ground voltage VSS. The first NMOS transistor MN1 may activate the high voltage detection signal HVD in response to the voltage acquired as the voltage of the first node ND1 that is divided by the voltage divider. The first PMOS transistor MP1 corresponds to a diode-connected transistor.

The first resistor R1 and the second resistor R2 are coupled in series between the second terminal of the first PMOS transistor MP1 and a ground voltage VSS. A first node ND1 locates between the first resistor R1 and the second resistor R2. The first node ND1 is coupled with the gate terminal of the first NMOS transistor MN1. In the case where the power supply voltage VDD is within the normal range as described above, the voltage of the first node ND1 has a voltage level lower than the threshold voltage of the first NMOS transistor MN1.

The first NMOS transistor MN1 has a first terminal which is coupled with the ground voltage VSS, the gate terminal which is coupled with the first node ND1, and a second terminal which is coupled with a second node ND2. The first NMOS transistor MN1 is turned on in response to the voltage of the first node ND1. If the power supply voltage VDD is larger than the predetermined voltage, the voltage of the first node ND1 becomes larger than the threshold voltage of the first NMOS transistor MN1, and thus the first NMOS transistor MN1 is turned on. Moreover, the high voltage detection unit 210 activates the high voltage detection signal HVD in response to a turn-on operation of the first NMOS transistor MN1.

The second PMOS transistor MP2 has a first terminal which is coupled with the power supply voltage VDD, the gate terminal which is applied with the ground voltage VSS, and a second terminal which is coupled with the second node ND2. Further, the second PMOS transistor MP2 is coupled between the first NMOS transistor MN1 and the power supply voltage VDD and configured to be turned on in response to the ground voltage VSS.

Operations of the high voltage detection unit 210 in accordance with an embodiment of the present disclosure will be described below. In the case where the power supply voltage VDD is within the normal range, that is, in a normal operating state, the voltage of the first node ND1 corresponding to the gate terminal of the first NMOS transistor MN1 is designed to be smaller than the threshold voltage of the first NMOS transistor MN1. For instance, design is made such that the voltage of the first node ND1 which is acquired through dividing the difference between the power supply voltage VDD and the threshold voltage value of the first PMOS transistor MP1 by the ratio between the first resistor R1 and the second resistor R2 is smaller than the threshold voltage of the first NMOS transistor MN1.

According to this fact, the first NMOS transistor MN1 retains a turned-off state, and the second PMOS transistor MP2 retains a turned-on state, by which the high voltage detection signal HVD retains a logic high state corresponding to the power supply voltage VDD. The high voltage detection signal HVD may correspond to a voltage of the second node ND2 between the first NMOS transistor MN1 and the second PMOS transistor MP2.

If the power supply voltage VDD becomes higher than the predetermined voltage, that is, in the case where a high voltage is detected, the voltage of the first node ND1 becomes larger than the threshold voltage of the first NMOS transistor MN1, and the first NMOS transistor MN1 is turned on. As both the second PMOS transistor MP2 and the first NMOS transistor MN1 are turned on, the high voltage detection signal HVD is changed to a logic low state corresponding to the ground voltage VSS, that is, is activated, by which a high voltage is detected.

The high voltage detection unit 210 in accordance with an embodiment of the present disclosure can detect a high voltage through a simple configuration while not needing a separate level shifter and so forth.

The high voltage detection unit 210 in accordance with an embodiment of the present disclosure may detect a voltage of 2.9˜3.5V at a temperature of −40° C. to 90° C. while a slight variation may occur according to the sizes of the respective transistors MP1, MP2 and MN1 and the values of the resistors R1 and R2. In the case where a high voltage is detected, the current flowing through the first NMOS transistor MN1 may correspond to about 0.5 μA to 0.8 μA. Further, a speed of detecting a high voltage may be improved. In the case where the power supply voltage VDD increases at the speed of about 5V/10 μs, a high voltage may be detected. Accordingly, it is possible to detect a high voltage at a speed faster than a time required for detecting a high voltage to protect an internal circuit (for example, in the case where a power supply voltage increases with the slope of 5V/53 μs).

Table 1 shows operation characteristics of the high voltage detection unit 210 in accordance with an embodiment of the present disclosure. In five examples which have various device characteristics according to process deviations, a detection level corresponds to a voltage of the gate terminal at which the first NMOS transistor MN1 is turned on, that is, the voltage of the first node ND1, and current corresponds to current which flows through the first NMOS transistor MN1.

TABLE 1

| | Operating | Detection | |
|---|---|---|---|
| | Temp. (° C.) | Level (V) | Current (μA) |
| Device | 90 | 3.2 | 0.7 |
| Characteristic 1 | −40 | 3.2 | 0.6 |
| Device | 90 | 2.8 | 0.8 |
| Characteristic 2 | −40 | 2.9 | 0.7 |
| Device | 90 | 3.5 | 0.6 |
| Characteristic 3 | −40 | 3.4 | 0.5 |
| Device | 90 | 2.9 | 0.6 |
| Characteristic 4 | −40 | 3.0 | 0.5 |
| Device | 90 | 3.3 | 0.7 |
| Characteristic 5 | −40 | 3.3 | 0.7 |

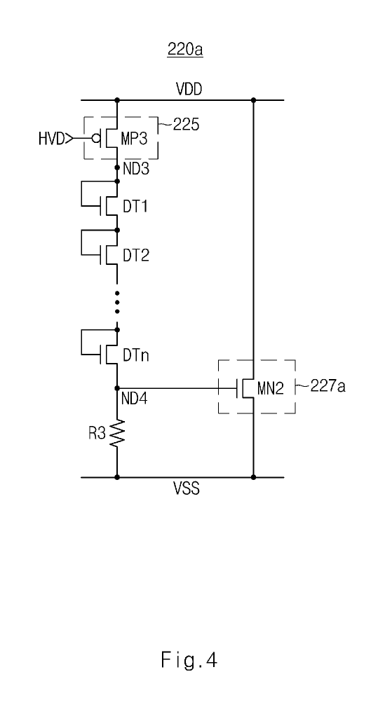

FIG. 4 is a circuit diagram showing an embodiment of the discharge unit of FIG. 2.

Referring to FIG. 4, a discharge unit 220a includes a high voltage responding section 225, a discharging section 227a, and a plurality of transistors DT1, DT2, . . . and DTn.

As the discharge unit 220a includes the high voltage responding section 225 which responds to the high voltage detection signal HVD, the discharging section 227a does not perform a discharging operation in direct response to the high voltage detection signal HVD. The discharge unit 220a allows the discharging section 227a to perform the discharging operation in response to an actual high voltage detecting operation which is performed in such a manner that the plurality of transistors DT1, DT2, . . . and DTn provided with the power supply voltage VDD in response to the high voltage detection signal HVD detect once more the level of the power supply voltage VDD. One or more voltage dropping elements or the plurality of diode transistors DT1, DT2, . . . and DTn may be configured between the high voltage responding section 225 and the ground voltage VSS. The discharging section 227a may be configured to perform the discharging operation in response to the voltage from the fourth node ND4 which may be dropped by one or more voltage dropping elements or the plurality of diode transistors DT1, DT2, . . . and DTn. This may be understood as a concept similar to filtering the high voltage detection signal HVD. The high voltage responding section 225 may be configured to provide the voltage of the fourth node ND4 in response to the high voltage detection signal HVD. The discharge unit 220a may be coupled to the first voltage in response to the high voltage detection signal HVD, and discharge the first voltage to a ground voltage VSS in response to a voltage level acquired by dropping the voltage.

For instance, the high voltage responding section 225 may include a third PMOS transistor MP3. The third PMOS transistor MP3 has a first terminal which is coupled with the power supply voltage VDD, the gate terminal which is applied with the high voltage detection signal HVD, and a second terminal which is coupled with a third node ND3. The third PMOS transistor MP3 may provide a first voltage to the one or more voltage dropping elements in response to the high voltage detection signal HVD which is activated.

Each of the plurality of diode transistors DT1, DT2, . . . and DTn has a shape of a diode-connected transistor in which the gate terminal and the drain terminal are coupled with each other. The number of the plurality of diode transistors DT1, DT2, . . . and DTn may be changed according to the level of the power supply voltage VDD for which the discharging operation is to be performed, the threshold voltage values or resistance components of the respective diode transistors DT1, DT2, . . . and DTn, and the discharge threshold of the discharging section 227a. According to an embodiment, the plurality of diode transistors DT1, DT2, . . . and DTn drop the power supply voltage VDD provided in response to the high voltage detection signal HVD, by a preset voltage, and provide a resultant voltage to a fourth node ND4. This may be understood as having the same concept as performing once more the high voltage detecting operation for the power supply voltage VDD.

In the case where the high voltage detection signal HVD is not activated, all elements of the discharge unit 220 do not operate. Accordingly, in the case where a high voltage is not detected, leakage current is not produced in the discharge unit 220. If the high voltage responding section 225 responding to the high voltage detection signal HVD is not provided, the power supply voltage VDD may continuously leak even in the case such as standby in which an operation is not performed, whereby power consumption is caused.

Therefore, the discharge unit 220 in accordance with an embodiment of the present disclosure may minimize power consumption.

The diode transistors DT1, DT2, . . . and DTn respectively drop the voltage of the third node ND3 by a predetermined amount or provide a voltage with a preselected level to the fourth node ND4 through a voltage dividing operation.

According to an embodiment, the plurality of diode transistors DT1, DT2, . . . and DTn may be constituted by any elements so long as they can drop a voltage, and may be referred to as voltage dropping elements. The one or more voltage dropping elements are provided with the first voltage from the high voltage responding section 225, drop the first voltage by a preset voltage, and provide the dropped first voltage. The voltage dropping elements are coupled with the ground voltage VSS through at least a third resistor R3.

The discharging section 227a performs a discharging operation in response to the voltage of the fourth node ND4. The discharging section 227a performs the discharging operation on the basis of a signal which is acquired by detecting once more the power supply voltage VDD in response to the operation of the high voltage responding section 225.

The voltage of the fourth node ND4 corresponds to a voltage which is generated as the increased power supply voltage VDD is provided through the plurality of diode transistors DT1, DT2, . . . and DTn when the third PMOS transistor MP3 is turned on in response to the high voltage detection signal HVD. Therefore, if the power supply voltage VDD does not reach a level higher than the predetermined level even though the third PMOS transistor MP3 is turned on in response to the high voltage detection signal HVD, the discharging section 227a does not perform the discharging operation.

On the contrary, if the high voltage responding section 225 is not provided, the voltage of the fourth node ND4 may increase by the instantaneous increase of the power supply voltage VDD. The discharge unit 220a of the present disclosure may detect once more a high voltage in response to one time detection of a high voltage by the high voltage detection unit 210, thereby preventing the occurrence of a phenomenon in which a discharging operation is performed according to instantaneous noise.

According to an embodiment, the discharging section 227a may include a second NMOS transistor MN2.

The second NMOS transistor MN2 has a first terminal which is coupled with the ground voltage VSS, the gate terminal which is coupled with the fourth node ND4 and applied with the dropped first voltage through the plurality of diode transistors DT1, DT2, . . . and DTn, and a second terminal which is coupled with the power supply voltage VDD. The second NMOS transistor MN2 is turned on when the dropped first voltage is larger than a predetermined voltage.

In the case where the voltage level of the fourth node ND4 is larger than the threshold voltage of the second NMOS transistor MN2, the second NMOS transistor MN2 is turned on, and the discharging operation is performed. Accordingly, the threshold voltage of the second NMOS transistor MN2 may be determined on the basis of the power supply voltage VDD for which the discharging operation is to be performed, the resistance components of the high voltage responding section 225 and the plurality of diode transistors DT1, DT2, . . . and DTn, and the resistance component of a third resistor R3.

For instance, in the case where the power supply voltage VDD of the discharge unit 220a in accordance with an embodiment of the present disclosure is 3V and the third resistor R3 is 10 kΩ, the following operation characteristics may be obtained at the temperature of −40° C. to 90° C. The current flowing through the plurality of diode transistors DT1, DT2, . . . and DTn corresponds to about 66 μA to 89 μA, and the discharging section 227a is turned on in response to about 0.6V to 0.96V. The current flowing through the discharging section 227a may be various as 4 mA to 223.2 mA.

The following Table 2 shows operation characteristic values for different device characteristics according to process deviations. The voltage of ND4 is a turn-on voltage of the discharging section 227a, diode current is current flowing through the plurality of diode transistors DT1, DT2, . . . and DTn, and discharge current (mA) corresponds to current flowing according to the discharging operation in the case where the discharging section 227a is turned on.

TABLE 2

| | Operating | | Diode | Discharge |
|---|---|---|---|---|
| | Temp. | Voltage of | Current | Current |
| | (° C.) | ND4 (V) | (μA) | (mA) |
| Device | 90 | 0.84 | 77 | 109.5 |
| Characteristic 1 | −40 | 0.70 | 77 | 35.6 |
| Device | 90 | 0.96 | 88 | 223.2 |
| Characteristic 2 | −40 | 0.82 | 90 | 127.6 |
| Device | 90 | 0.73 | 67 | 40.4 |
| Characteristic 3 | −40 | 0.60 | 66 | 4.0 |
| Device | 90 | 0.96 | 88 | 218.1 |
| Characteristic 4 | −40 | 0.81 | 89 | 123.9 |
| Device | 90 | 0.73 | 67 | 40.6 |
| Characteristic 5 | −40 | 0.60 | 66 | 4.0 |

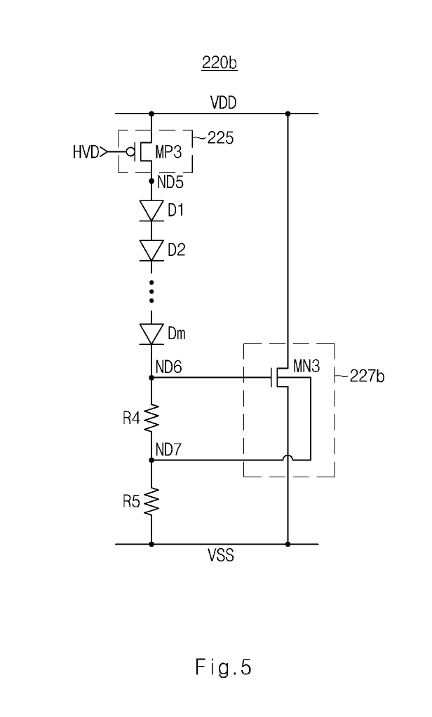

FIG. 5 is a circuit diagram showing an embodiment of the discharge unit of FIG. 2.

Referring to FIG. 5, a discharge unit 220b includes a high voltage responding section 225, a plurality of diodes D1, D2, . . . and Dm, and a discharging section 227b. The discharge unit 220b may further include a fourth resistor R4 and a fifth resistor R5. The third PMOS transistor MP3 is also illustrated.

The high voltage responding section 225, the plurality of diodes D1, D2, . . . and Dm, and the fourth resistor R4 and the fifth resistor R5 are coupled in series between the power supply voltage VDD and the ground voltage VSS.

As described above with reference to FIG. 4, the high voltage responding section 225 is configured to provide the power supply voltage VDD to a fifth node ND5 in response to the high voltage detection signal HVD.

Similarly to the plurality of diode transistors DT1, DT2, . . . and DTn shown in FIG. 4, the plurality of diodes D1, D2, . . . and Dm perform operations of passing current in one direction, dropping a voltage and providing a dropped voltage. The plurality of diodes D1, D2, . . . and Dm may be referred to as voltage dropping elements.

The discharging section 227b is coupled between the power supply voltage VDD and the ground voltage VSS, responds to the voltage of a sixth node ND6, and is triggered in response to the voltage of a seventh node ND7. According to an embodiment, the discharging section 227b may include a third NMOS transistor MN3.

The third NMOS transistor MN3 has a first terminal which is coupled with the ground voltage VSS, the gate terminal which is coupled with the sixth node ND6, a second terminal which is coupled with the power supply voltage VDD, and a body (substrate) which is coupled with the seventh node ND7. The body (substrate) may be applied with a voltage lower than a dropped first voltage.

The discharging section 227b may perform a discharging operation by performing a BJT (bipolar junction transistor) operation on the basis of the voltages of the sixth node ND6 and the seventh node ND7. For instance, in the discharging section 227b, the first terminal coupled with the ground voltage VSS may correspond to the emitter, the seventh node ND7 coupled with the body may correspond to the base, and the second terminal coupled with the power supply voltage VDD may correspond to the collector. The discharging section 227b may perform the discharging operation by operating like a BJT element.

In general, as in the third NMOS transistor MN3, in the case where a voltage is applied to the body of a transistor, the transistor may be turned on even when the voltage of the sixth node ND6 is considerably low. Also, as protective capacitance increases, it is possible to stably perform the function of a protection circuit.

The high voltage detection unit 210 in accordance with an embodiment of the present disclosure may stably detect a high voltage through a configuration which is simple and has low power consumption. Also, the discharging unit 220 is configured not to directly respond to a high voltage but to perform a high voltage discharging operation in response to a signal detected by the high voltage detection unit 210. Further, the discharging unit 220 is configured to perform a discharging operation by additionally detecting a high voltage even when the high voltage detection unit 210 erroneously detects a high voltage.

As a consequence, advantages are provided in that high voltage detection is possible while reducing power consumption, and a discharging operation for a low voltage level is possible in the case where an integrated circuit which operates at a lower voltage level as in a mobile appliance is included.

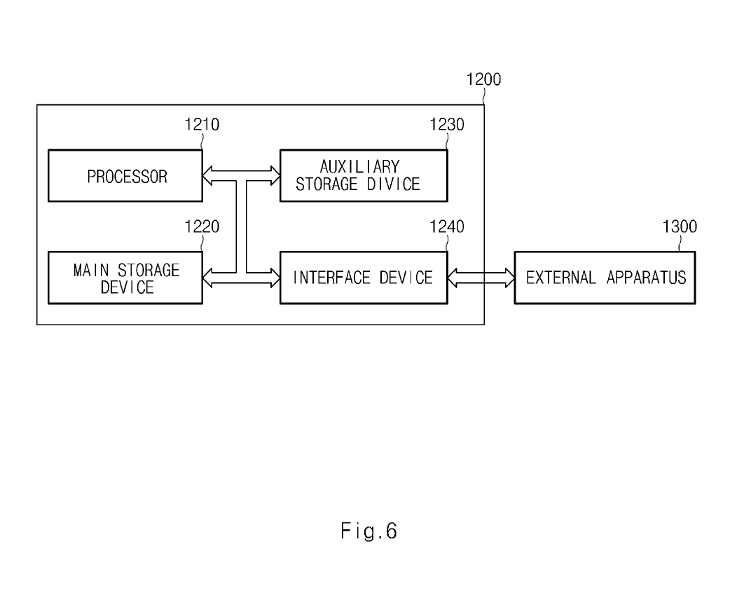

Referring to FIG. 6, a system 1200 to which the apparatus described above may be applied can be configured as a data processing apparatus. The system 1200 may perform input, processing, output, communication, storage, and the like to perform a series of operations on data, and include a processor 1210, a main storage device 1220, an auxiliary storage device 1230, and an interface device 1240. The system 1200 according to an embodiment may be a variety of electronic systems that may operate by using a processor, such as a computer, a server, a personal digital assistant (PDA), a portable computer, a web tablet, a wireless phone, a smart phone, a digital music player, a portable multimedia player (PMP), a camera, a global positioning system (GPS), a video camera, a voice recorder, or a smart television.

The main storage device 1220 may include a protection circuit 200 according to an embodiment of the present invention described above. Particularly, the main storage device 1220 may include high voltage detection unit 210 and the discharging unit 220. Thus, the main storage device 1220 may stably detect a high voltage through a configuration which is simple and has low power consumption and not directly respond to a high voltage but to perform a high voltage discharging operation.

The processor 1210 may be a configuration of the system 1200 that may control interpretation of an input command from an external apparatus 1300 and processing of an operation, comparison, and the like of data stored in the system, and may be formed of a graphic processing unit (GPU), an application processor (AP), a digital signal processor (DSP), or the like.

The main storage device 1220 may receive a program or data from the auxiliary storage device 1230 and execute the program or the data. The main storage device 1220 may retain the stored content even in a power off position, and may include the apparatus according to various embodiments described above.

The auxiliary storage device 1230 may store program code or data. In addition, the auxiliary storage device 1230 may have a lower data processing rate than that of the main storage device 1220, but may store a large amount of data and also include the apparatus of the various embodiments described above. The auxiliary storage device 1230 may further include a data storage system such as a memory stick card or smart media card or the like.

The interface device 1240 may exchange a command and data of an external apparatus, and may be a keypad, a keyboard, a mouse, a speaker, a mike, a display, or a communication device. The communication device may include all modules such as a module coupled to a wired network or a module coupled to a wireless network. The wired network module may include an Ethernet, a power line communication (PLC) or the like. The wireless network module may include Infrared Data Association (IrDA), Code Division Multiple Access (CDMA), Time Division Multiple Access (TDMA) or the like.

While certain embodiments have been described above, it will be understood to those skilled in the art that the embodiments described are by way of example only. Accordingly, the protection circuit and the protection apparatus including the same described herein should not be limited based on the described embodiments. Rather, the protection circuit and the protection apparatus including the same described herein should only be limited in light of the claims that follow when taken in conjunction with the above description and accompanying drawings.

What is claimed is:

1. A protection circuit comprising:
a high voltage detection unit configured to activate a high voltage detection signal where a first voltage exceeds a predetermined voltage; and
a discharge unit coupled with the first voltage in response to the high voltage detection signal, and configured to discharge the first voltage to a ground voltage in response to a voltage level acquired by dropping the first voltage.

2. The protection circuit according to claim 1, wherein the high voltage detection unit comprises a first transistor coupled between the first voltage and the ground voltage turned on in response to the first voltage, and activates the high voltage detection signal in response to a turn-on operation of the first transistor.

3. The protection circuit according to claim 1,
wherein the high voltage detection unit further comprises a second transistor and a voltage divider which are coupled in series between the first voltage and the ground voltage, and
wherein the first transistor activates the high voltage detection signal in response to a voltage acquired as the first voltage is divided by the voltage divider.

4. The protection circuit according to claim 3, wherein the second transistor corresponds to a diode-connected transistor.

5. The protection circuit according to claim 3, wherein the high voltage detection unit further comprises:
a third transistor coupled between the first transistor and the first voltage and configured to be turned on in response to the ground voltage.

6. The protection circuit according to claim 5, wherein the high voltage detection signal corresponds to a voltage of a node between the third transistor and the first transistor.

7. The protection circuit according to claim 1, wherein the discharge unit comprises:
a high voltage responding section configured to provide the first voltage in response to the high voltage detection signal;
one or more voltage dropping elements coupled between the high voltage responding section and the ground voltage; and
a discharging section configured to perform a discharging operation in response to the first voltage dropped by the one or more voltage dropping elements.

8. The protection circuit according to claim 7, wherein the high voltage responding section comprises a transistor which provides the first voltage to the one or more voltage dropping elements in response to the high voltage detection signal which is activated.

9. The protection circuit according to claim 7,
wherein the one or more voltage dropping elements are provided with the first voltage from the high voltage responding section, drop the first voltage by a preset voltage, and provide the dropped first voltage, and
wherein the one or more voltage dropping elements are coupled with the ground voltage through one or more resistor elements.

10. The protection circuit according to claim 9, wherein the one or more voltage dropping elements comprise diode-connected transistors or diode elements.

11. The protection circuit according to claim 7, wherein the discharging section comprises a transistor having a first terminal which is coupled with the first voltage, a gate terminal which is applied with the dropped first voltage and a second terminal which is coupled with the ground voltage, the transistor being turned on when the dropped first voltage is larger than a predetermined voltage.

12. The protection circuit according to claim 9, wherein the discharging section further comprises a body (substrate) which is applied with a voltage lower than the dropped first voltage.

13. A protection apparatus comprising:
a protection circuit configured to activate a high voltage detection signal where a first voltage exceeds a predetermined voltage, and perform a discharging operation in response to the activated high voltage detection signal; and
an internal circuit provided with the first voltage through the protection circuit.

14. The protection apparatus according to claim 13, wherein the protection circuit comprises:
a high voltage detection unit including a first transistor which is turned on where the first voltage exceeds the predetermined voltage; and
a discharge unit configured to be coupled with the first voltage in response to the activated high voltage detection signal, and discharge the first voltage to a ground voltage in response to a voltage level acquired by dropping the first voltage.

15. The protection apparatus according to claim 14,
wherein the high voltage detection unit further comprises at least one voltage dropping element and a voltage divider which are coupled in series between the first voltage and the ground voltage, and
wherein the first transistor activates the high voltage detection signal in response to a voltage acquired as the first voltage is divided by the voltage divider.

16. The protection apparatus according to claim 15, wherein the high voltage detection unit further comprises:
a second transistor coupled between the first transistor and a first voltage and configured to be turned on in response to the ground voltage.

17. The protection apparatus according to claim 16, wherein the high voltage detection signal corresponds to a voltage of a node between the second transistor and the first transistor.

18. The protection apparatus according to claim 13, wherein the discharge unit comprises:
a high voltage responding section configured to provide the first voltage in response to the high voltage detection signal;
one or more voltage dropping elements coupled between the high voltage responding section and the ground voltage; and
a discharging section configured to perform a discharging operation in response to the first voltage dropped by the one or more voltage dropping elements.

19. The protection apparatus according to claim 18, wherein the high voltage responding section comprises a transistor which provides the first voltage to the one or more voltage dropping elements in response to the high voltage detection signal which is activated.

20. The protection apparatus according to claim 18,
wherein the one or more voltage dropping elements are provided with the first voltage from the high voltage responding section, drop the first voltage by a preset voltage, and provide the dropped first voltage, and
wherein the one or more voltage dropping elements are coupled with the ground voltage through one or more resistor elements.
